(19) United States
(12) Patent Application Publication
(10) Pub. No.: US 2018/0165320 A1
(43) Pub. Date: Jun. 14, 2018

(54) DATABASE TABLE ADAPTION TO INCOMPATIBLE CHANGES

(71) Applicant: SAP SE, Walldorf (DE)

(72) Inventor: HORST SCHAUDE, Kraichtal (DE)

(21) Appl. No.: 15/378,024

(22) Filed: Dec. 13, 2016

(51) Int. Cl. G06F 17/30

(52) U.S. Cl. CPC G06F 17/30365; G06F 17/30312; G06F 17/3051; G06F 17/30339

(57) ABSTRACT

Various embodiments of systems, computer program products, and methods to adapt database table to incompatible changes are described herein. In an aspect, a data repository is instructed to modify a database table based on a current definition of an element corresponding to a node of a data entity. Further, an error message is received when the current definition of the element is incompatible with a definition associated with a column of the database table. A check is made to determine whether an error is a data type change error by analyzing the error message. The definition of the column of the database table is compared with the current definition of the element when the error is the data type change error. Based on the comparison, the database table is triggered for database table adaption corresponding to the current definition of the element.

### BACKGROUND

Data entities can be structured objects including a root node and child nodes (e.g., a sales order having a company name as a root node and other information associated with the order as child nodes) used for processing an application. Further, a node may be defined by a list of elements. Languages such as business object description language (BODL) may be used to model or define data entities. In BODL, the elements associated with the data entities are defined by specific data types for storing data in database tables. During development, definitions of elements corresponding to nodes may be changed (e.g., adding fields, change in sequence, and change in data types). Further, some changes (e.g., change in data types) can be incompatible with a corresponding database table. Therefore, a developer may have to clean a data entity leading to removal of the database table (e.g., data loss), or revert the change or reactivate the database table. e.g., to add an element with a new data type.

### BRIEF DESCRIPTION OF THE DRAWINGS

The embodiments are illustrated by way of examples and not by way of limitation in the figures of the accompanying drawings in which like references indicate similar elements. The embodiments may be best understood from the following detailed description taken in conjunction with the accompanying drawings.

FIG. 1 is a block diagram of an example computing environment illustrating adaption of a database table in a data repository to incompatible changes, according to an embodiment.

FIG. 2 is a flow diagram illustrating an example process to adapt a database table to incompatible changes, according to an embodiment.

FIG. 3 is a sequence diagram illustrating an example data flow between a data entity compiler, an error message analyzer, a definitions comparator, a database table adaption unit and a data repository, according to an embodiment.

FIG. 4 is a block diagram illustrating an example computer system, according to an embodiment.

### DETAILED DESCRIPTION

Embodiments of techniques to adapt database table to incompatible changes are described herein. In the following description, numerous specific details are set forth to provide a thorough understanding of the embodiments. One skilled in the relevant art will recognize, however, that the embodiments can be practiced without one or more of the specific details, or with other methods, components, materials, etc. In other instance, well-known structures, materials, or operations are not shown or described in detail.

Reference throughout this specification to “one embodiment”, “this embodiment” and similar phrases, means that a particular feature, structure, or characteristic described in connection with the embodiment is included in at least one of the one or more embodiments. Thus, the appearances of these phrases in various places throughout this specification are not necessarily all referring to the same embodiment. Furthermore, the particular features, structures, or characteristics may be combined in any suitable manner in one or more embodiments.

In this document, various methods, processes and procedures are detailed. Although particular steps may be described in a certain sequence, such sequence may be mainly for convenience and clarity. A particular step may be repeated more than once, may occur before or after other steps (even if those steps are otherwise described in another sequence), and may occur in parallel with other steps. Further, a step may be executed upon executing another step. Such a situation may be specifically pointed out when not clear from the context. A particular step may be omitted. Further, it is to be understood that the various actions (retrieving, determining, transmitting, rendering, triggering and so on) may be performed by a hardware device (e.g., computing system), even if the action may be authorized, initiated or triggered by a user, or even if the hardware device is controlled by a computer program, software, firmware, and the like.

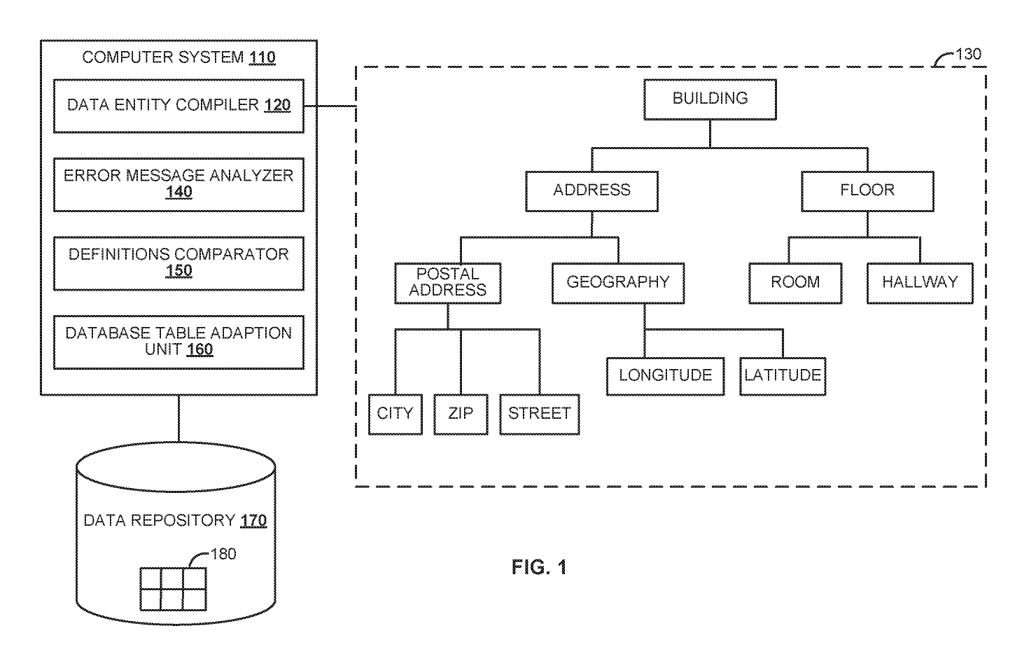

FIG. 1 is a block diagram of an example computing environment illustrating adaption of database table 180 in data repository 170 to incompatible changes, according to an embodiment. The computing environment may include computer system 110 connected to the data repository 170 to store data associated with data entity 130. The data entity 130 can be referred to as application data or a business object or a data object, which includes data associated with one or more applications. The application can be related to, but not limited to, accounting, collaboration, customer relationship management (CRM), management information systems (MIS), enterprise resource planning (ERP), invoicing, human resource management (HRM), content management (CM) and service desk management.

In one example, the data entity 130 may include physical objects (e.g., “building”), logical objects (e.g., “employee”) and business transactions (e.g., “sales order”). The data entity 130 can be structured objects including a root node (e.g., “building”), child nodes (e.g., “address”, “floor”, “postal address”, “geography”. “room”, “hallway”) and relationships between nodes. Further, a node may be defined by a number of elements with corresponding data types. The elements may be defined using languages such as business object description language (BODL). For example, the elements associated with the node “postal address” can include “city” (e.g., data type “character” with a length up to one hundred characters), “zip” (e.g., data type “numeral” with 5-digits length) and “street” (e.g., data type “alphanumeric” with a length of up to twenty alphanumeric symbols), and the elements of node “geography” can be “longitude” and “latitude”. Further, relationships between the nodes can be defined by cardinality between the nodes. For example, one to one (i.e., one target node, e.g., “address of a building”), one to many (i.e., many target nodes, e.g., “multiple floors of a building”), etc.

The data repository 170 may include one or more database tables (e.g., 180) for storing the data associated with the data entity 130. The database table 180 may include columns representing elements (e.g., “city”, “zip”, “street” and “country”) associated with the node (e.g., “address”) and rows representing actual data, for example. During development, definitions of the elements (e.g., “city”, “zip”, “street” and “country”) associated with the node (e.g., “address”) of the data entity 130 may be changed. For example, add fields, change in sequence, change in data types and the like, which can be compatible or incompatible with the corresponding database table 180.

In one embodiment, the data entity compiler 120 receives changed definition of an element associated with a node of the data entity 130. Further, the data entity compiler 120 instructs the data repository 170 to modify the database table 180 based on a current definition of the element, e.g., provided during the development phase. In one example, when the change in definition of the element is compatible with the corresponding database table 180, the database table 180 is modified corresponding to the changed definition of the element. When the change in definition of the element is incompatible with the corresponding database table 180, an error message indicating failure to modify the database table 180 may be generated. In one embodiment, the computer system 110 may include components such as error message analyzer 140, definitions comparator 150 and database table adaption unit 160 for adapting the database table 180 to incompatible changes.

In one embodiment, the error message analyzer 140 analyzes the error message to determine whether an error is a data type change error. When the error is not a data type change error, a message may be rendered for manual modification of the database table 180 corresponding to the current and changed definition of the element. When the error is a data type change error, the definition corresponding to a corresponding column of the database table 180 is compared with the current definition of the element by the definitions comparator 150, for example.

Based on the comparison between the definition corresponding to a corresponding column of the database table 180 and the current definition of the element, the database table adaption unit 160 triggers the database table 180 for database table adaption corresponding to the current definition of the element when the definition of the column supports the current definition of the element. For example, when the definition of the column (e.g., data type “numeral” with 10-digits length) supports the current definition of the element (e.g., data type “character” with a length up to ten characters), the database table 180 is triggered for database table adaption corresponding to the current definition of the element.

When the definition of the column (e.g., data type “character” with a length up to one hundred characters) partially supports the current definition of the element (e.g., data type “character” with a length up to one hundred and twenty five characters), a message is rendered for authorization for adapting the database table 180. When the definition of the column (e.g., data type “character” with a length up to one hundred characters) does not support the current definition of the element (e.g., data type “numeral” with 100-digits length), the message is rendered for manual adaption of the database table 180 indicating possible data loss due to adapting the database table to store the data. Others examples for compatible change can be same data type and increase in length. The partial compatible change can be new data type (e.g., “character”) incorporating existing data type (e.g., “numeral”). The incompatible change can be new data type (e.g., “numeral”) is a subset of existing data type (e.g., “character”). Therefore, minimizing the possible data loss and the effort by a developer to complete the database table 180 adaptions during the change in the definition of the elements can be achieved.

In one embodiment, the components (e.g., the data entity compiler 120, the error message analyzer 140, the definitions comparator 150 and the database table adaption unit 160) can be included in the computer system 110 and/or in different computer systems. The computer system can include one or more processors. For example, the computer system can be a computer, server, workstation, mobile device, embedded system or other device having at least one processor and memory. The computer system can include a communication port or input/output device for communicating over wired or wireless communications.

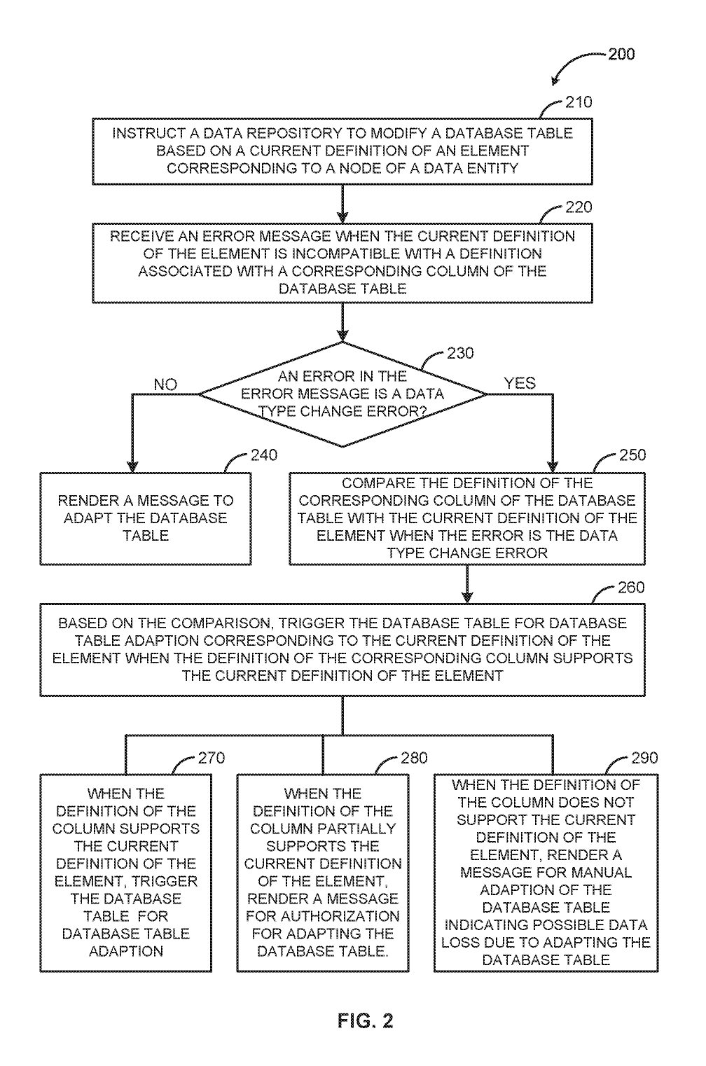

FIG. 2 is a flow diagram illustrating example process 200 to adapt a database table to incompatible changes, according to an embodiment. At 210, a data repository is instructed to modify a database table based on a current definition of an element corresponding to a node of a data entity. Examples for the data entity or a business object or an entity can be, but not limited to service order, employee and customer. Further, the data entity includes one or more nodes and relationships (e.g., one to one and one to many) between the nodes. The nodes may include one or more elements defined by data types.

The database table in the data repository may include one or more columns and one or more rows, for example. Further, the elements (e.g., “city”, “country”, “street” and “zip”) of the node (e.g., “address”) could be mapped to the columns of the database table. The rows represent actual data. In one example, the elements of the node are defined by business object description language (BODL). In BODL, the elements (e.g., “city”, “zip”, “street”, “country” and the like) are defined with different data types (e.g., “character”, “numeral”, “alphanumeric” and the like). Further, length of the data types is defined. During development, definition of nodes may be changed such as, but not limited to, adding nodes, deleting nodes, adding elements, deleting elements, change in sequence, change in data types of elements. The changes can be compatible or incompatible with the underlying data repository. For example, the compatibility can be determined by, but not limited to mapping corresponding data types (e.g., mapping data types of the elements in the data repository and the current definition of the elements).

In one example, when the current definition of an element is compatible with the definition of the corresponding column of a database table, the column definition is modified corresponding to the current definition of the element. Further, when an instruction to add/delete a node is received, a database table is added/removed in the data repository. Also, when add/delete an element is received, a column in corresponding database table is added/removed.

In one embodiment, incompatible changes corresponding to the underlying data repository may be received. An example of incompatible change may include change of the sequence (e.g., from element A defined by data type “humeral” storing integer values (e.g., date) and element B defined by data type “numeral” storing decimal values to element A defined by data type “numeral” storing decimal values and element B defined by data type “numeral” storing integer values (e.g., date), respectively). In one example, when the current definition of the element is incompatible with the definition of the corresponding column of the database table, an error message is generated.

At 220, the error message is received, e.g., when the current definition of the element is incompatible with the definition associated with the corresponding column of the database table. At 230, a check is performed to determine whether the reported error is a data type change error by analyzing the error message. In one example, when the error is not because of the data type change, a message is rendered to a developer to manually adapt the database table corresponding to the current definition of the element, at 240.

At 250, the definition of the corresponding column of the database table is compared with the current definition of the element when the error is a data type change error. An example of incompatible changes due to change in the data type may include change of element A defined by data type “numeral” storing integer values (e.g., date) to element A defined by data type “numeral” storing decimal values”.

At 260, based on the comparison, the database table is triggered for database table adaption corresponding to the current definition of the element when the definition of the corresponding column supports the current definition of the element.

In one embodiment, the database table adaption depends on the comparison between the current definition of the element and the definition of the corresponding column of the database table. For example, when the definition of the column (e.g., data type “numeral” with 10-digits length) supports the current definition of the element (e.g., data type “character” with a length up to ten characters), the database table is triggered for database table adaption, at 270. When the definition of the column (e.g., data type “character” with a length up to one hundred characters) partially supports the current definition of the element (e.g., data type “character” with a length up to one hundred and twenty five characters), a message is rendered for authorization for adapting the database table, at 280. When the definition of the column (e.g., data type “character” with a length up to one hundred characters) does not support the current definition of the element (e.g., data type “numeral” with 100-digits length), a message is rendered for manual adaption of the database table indicating possible data loss due to adapting the database table, at 290.

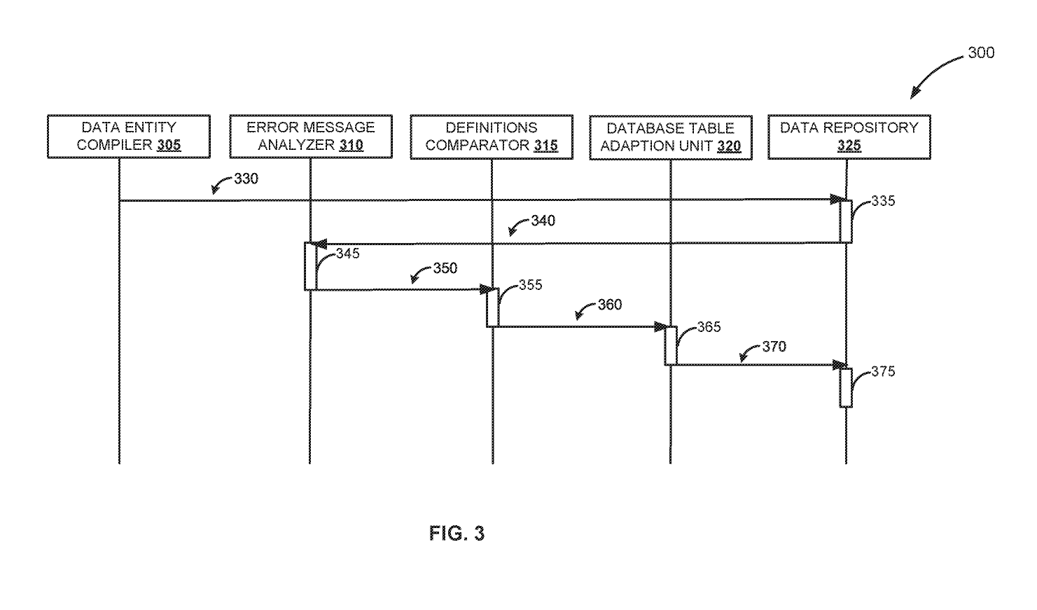

FIG. 3 is a sequence diagram illustrating example data flow 300 between data entity compiler 305, error message analyzer 310, definitions comparator 315, database table adaption unit 320 and data repository 325, according to an embodiment. The sequence diagram represents the interactions and the operations involved between the data entity compiler 305, the error message analyzer 310, the definitions comparator 315, the database table adaption unit 320 and the data repository 325. The vertical lines of the data entity compiler 305, the error message analyzer 310, the definitions comparator 315, the database table adaption unit 320 and the data repository 325 represent the processes that may exist simultaneously. The horizontal arrows (e.g., 330, 340, 350, 360 and 370) represent the process steps between the vertical lines representing their respective process objects (e.g., the data entity compiler 305, the error message analyzer 310, the definitions comparator 315, the database table adaption unit 320 and the data repository 325). Activation boxes (e.g., 335, 345, 355, 365 and 375) between the horizontal arrows represent the processes performed in the respective process object.

At 330, a data repository is instructed to modify a database table based on a current definition of an element corresponding to a node of a data entity. The database table may include one or more columns mapped to the elements of the node. At 335, a check is made to determine whether the current definition of the element is compatible with corresponding column of the database table. In one example, the elements of the node in the data entity are defined using languages such as business object description language (BODL). Further, the definition of the elements may include a specific data type. In one scenario, when the current definition of the element is compatible with the definition of the column, the definition of the column in the database table is modified based on the current definition of the element. In another scenario, when the current definition of the element is incompatible with the definition of the column, an error message indicating failure to modify the database table is received by the error message analyzer 310 at 340.

At 345, the error message analyzer 310 determines an error based on analyzing the error message. In other words, a check is made to determine whether the error is a data type change error. When the error is not the data type change error, a message is rendered for manual adaption of the database table corresponding to the current definition of the element. In one embodiment, when the error is the data type change error, the error message is sent to the definitions comparator 315, at 350. The definitions comparator 315 compares the current definition of the element with the definition of the column in the database table, at 355.

At 360, the comparison result is sent to the database table adaption unit 320. At 365, a check is made to determine whether to trigger adaption of the database table based on the comparison results. When the decision is made to trigger adaption of the database table, the database table is triggered for database table adaption corresponding to the current definition of the element, at 370. For example, when the definition of the column (e.g., data type “numeral” with 10 digits length) supports the current definition of the element (e.g., “character” with 10 characters length), the database table is triggered for database table adaption. When the definition of the column (e.g., data type “character” with 100 digits length) partially supports the current definition of the element (e.g., “character” with 125 characters length), the message is rendered for authorization for adapting the database table. When the definition of the column (e.g., data type “character” with 100 digits length) does not support the current definition of the element (e.g., “numeral” with 100 digits length), the message is rendered for manual adaption of the database table indicating possible data loss due to adapting the database table. Therefore, based on the comparison result, the database table in the data repository 325 is adaption corresponding to the current definition of the element, at 375.

Some embodiments may include the above-described methods being written as one or more software components. These components, and the functionality associated with them, may be used by client, server, distributed, or peer computer systems. These components may be written in a computer language corresponding to one or more programming languages such as, functional, declarative, procedural, object-oriented, lower level languages and the like. They may be linked to other components via various application programming interfaces and then compiled into one complete application for a server or a client. Alternatively, the components maybe implemented in server and client applications. Further, these components may be linked together via various distributed programming protocols. Some example embodiments may include remote procedure calls being used to implement one or more of these components across a distributed programming environment. For example, a logic level may reside on a first computer system that is remotely located from a second computer system containing an interface level (e.g., a graphical user interface). These first and second computer systems can be configured in a server-client, peer-to-peer, or some other configuration. The clients can vary in complexity from mobile and handheld devices, to thin clients and on to thick clients or even other servers.

The above-illustrated software components are tangibly stored on a computer readable storage medium as instructions. The term “computer readable storage medium” includes a single medium or multiple media that stores one or more sets of instructions. The term “computer readable storage medium” includes physical article that is capable of undergoing a set of physical changes to physically store, encode, or otherwise carry a set of instructions for execution by a computer system which causes the computer system to perform the methods or process steps described, represented, or illustrated herein. A computer readable storage medium may be a non-transitory computer readable storage medium. Examples of a non-transitory computer readable storage media include, but are not limited to: magnetic media, such as hard disks, floppy disks, and magnetic tape; optical media such as CD-ROMs, DVDs and holographic indicator devices; magneto-optical media; and hardware devices that are specially configured to store and execute, such as application-specific integrated circuits (“ASICs”), programmable logic devices (“PLDs”) and ROM and RAM devices. Examples of computer readable instructions include machine code, such as produced by a compiler, and files containing higher-level code that are executed by a computer using an interpreter. For example, an embodiment may be implemented using Java, C++, or other object-oriented programming language and development tools. Another embodiment may be implemented in hard-wired circuitry in place of, or in combination with machine readable software instructions.

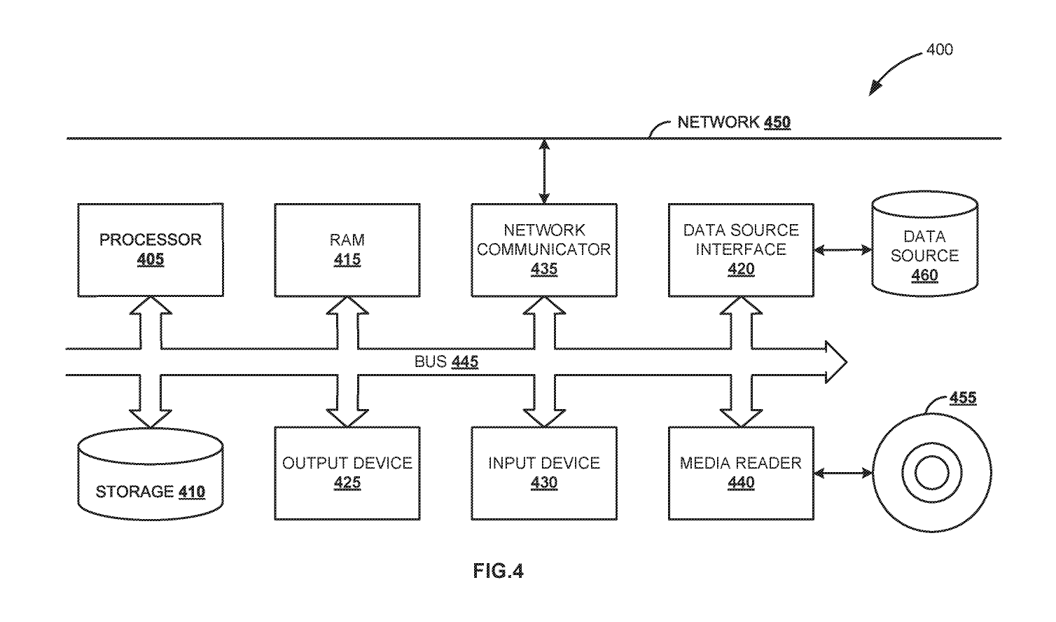

FIG. 4 is a block diagram of example computer system 400, according to an embodiment. The computer system 400 includes a processor 405 that executes software instructions or code stored on a computer readable storage medium 455 to perform the above-illustrated methods. The processor 405 can include a plurality of cores. The computer system 400 includes a media reader 440 to read the instructions from the computer readable storage medium 455 and store the instructions in storage 410 or in random access memory (RAM) 415. The storage 410 provides a large space for keeping static data where at least some instructions could be stored for later execution. According to some embodiments, such as some in-memory computing system embodiments, the RAM 415 can have storage capacity to store much of the data required for processing in the RAM 415 instead of in the storage 410. In some embodiments, the data required for processing may be stored in the RAM 415. The stored instructions may be further compiled to generate other representations of the instructions and dynamically stored in the RAM 415. The processor 405 reads instructions from the RAM 415 and performs actions as instructed. According to one embodiment, the computer system 400 further includes an output device 425 (e.g., a display) to provide at least some of the results of the execution as output including, but not limited to, visual information to users and an input device 430 to provide a user or another device with means for entering data and/or otherwise interact with the computer system 400. One or more of these output devices 425 and input devices 430 could be joined by one or more additional peripherals to further expand the capabilities of the computer system 400. A network communicator 435 may be provided to connect the computer system 400 to a network 450 and in turn to other devices connected to the network 450 including other clients, servers, data stores, and interfaces, for instance. The modules of the computer system 400 are interconnected via a bus 445. Computer system 400 includes a data source interface 420 to access data source 460. The data source 460 can be accessed via one or more abstraction layers implemented in hardware or software. For example, the data source 460 may be accessed by network 450. In some embodiments, the data source 460 may be accessed via an abstraction layer, such as, a semantic layer.

A data source is an information resource. Data sources include sources of data that enable data storage and retrieval. Data sources may include databases, such as, relational, transactional, hierarchical, multi-dimensional (e.g., OLAP), object oriented databases, and the like. Further data sources include tabular data (e.g., spreadsheets, delimited text files), data tagged with a markup language (e.g., XML data), transactional data, unstructured data (e.g., text files, screen scrapings), hierarchical data (e.g., data in a file system, XML data), files, a plurality of reports, and any other data source accessible through an established protocol, such as, Open Database Connectivity (ODBC), produced by an underlying software system, e.g., an enterprise resource planning (ERP) system, and the like. Data sources may also include a data source where the data is not tangibly stored or otherwise ephemeral such as data streams, broadcast data, and the like. These data sources can include associated data foundations, semantic layers, management systems, security systems and so on.

In the above description, numerous specific details are set forth to provide a thorough understanding of embodiments. One skilled in the relevant art will recognize, however that the one or more embodiments can be practiced without one or more of the specific details or with other methods, components, techniques, etc. In other instances, well-known operations or structures are not shown or described in details.

Although the processes illustrated and described herein include series of steps, it will be appreciated that the different embodiments are not limited by the illustrated ordering of steps, as some steps may occur in different orders, some concurrently with other steps apart from that shown and described herein. In addition, not all illustrated steps may be required to implement a methodology in accordance with the one or more embodiments. Moreover, it will be appreciated that the processes may be implemented in association with the apparatus and systems illustrated and described herein as well as in association with other systems not illustrated.

The above descriptions and illustrations of embodiments, including what is described in the Abstract, is not intended to be exhaustive or to limit the one or more embodiments to the precise forms disclosed. While specific embodiments of, and examples for, the embodiment are described herein for illustrative purposes, various equivalent modifications are possible within the scope of the embodiments, as those skilled in the relevant art will recognize. These modifications can be made to the embodiments in light of the above detailed description. Rather, the scope of the one or more embodiments is to be determined by the following claims, which are to be interpreted in accordance with established doctrines of claim construction.

What is claimed is:

1. A non-transitory computer readable storage medium storing instructions, which when executed by a computer cause the computer to:
instruct a data repository to modify a database table based on a current definition of an element corresponding to a node of a data entity;
receive an error message when the current definition of the element is incompatible with a definition associated with a corresponding column of the database table;
determine whether an error is a data type change error by analyzing the error message;
compare the definition of the corresponding column of the database table and the current definition of the element when the error is the data type change error; and
based on the comparison, trigger the database table for database table adaption corresponding to the current definition of the element when the definition of the corresponding column supports the current definition of the element.

2. The non-transitory computer-readable medium of claim 1, wherein the database table in the data repository comprises one or more columns mapped to one or more elements associated with the node of the data entity and one or more rows storing data.

3. The non-transitory computer-readable medium of claim 1, wherein when the current definition of the element is compatible with the definition of the corresponding column of the database table, modify the definition of the corresponding column to the current definition of the element.

4. The non-transitory computer-readable medium of claim 1, wherein when the error is not the data type change error, render a message to adapt the database table.

5. The non-transitory computer-readable medium of claim 1, wherein based on the comparison, when the definition of the corresponding column does not support the current definition of the element, render a message for manual adaption of the database table indicating possible data loss due to adapting the database table.

6. The non-transitory computer-readable medium of claim 1, wherein based on the comparison, when the definition of the corresponding column partially supports the current definition of the element, render a message for authorization to adapt the database table.

7. The non-transitory computer-readable medium of claim 1, wherein the data entity comprises a plurality of nodes and relationships between the plurality of nodes, and the plurality of nodes comprises one or more elements defined by data types.

8. A computer implemented method to adapt a database table to incompatible changes, comprising:
instructing, by a data entity compiler, a data repository to modify the database table based on a current definition of an element corresponding to a node of a data entity;
receiving an error message when the current definition of the element is incompatible with a definition associated with a corresponding column of the database table;
determining, by a error message analyzer, whether an error is a data type change error by analyzing the error message;
comparing, by a definitions comparator, the definition of the corresponding column of the database table and the current definition of the element when the error is the data type change error; and
based on the comparison, triggering, by a database table adaption unit, the database table for database table adaption corresponding to the current definition of the element when the definition of the corresponding column supports the current definition of the element.

9. The computer implemented method of claim 8, wherein the database table in the data repository comprises one or more columns mapped to one or more elements associated with the node of the data entity and one or more rows storing data.

10. The computer implemented method of claim 8, wherein when the current definition of the element is compatible with the definition of the corresponding column of the database table, modifying the definition of the corresponding column to the current definition of the element.

11. The computer implemented method of claim 8, wherein when the error is not the data type change error, rendering a message to adapt the database table.

12. The computer implemented method of claim 8, wherein based on the comparison, when the definition of the corresponding column does not support the current definition of the element, rendering a message for manual adaption of the database table indicating possible data loss due to adapting the database table.

13. The computer implemented method of claim 8, wherein based on the comparison, when the definition of the corresponding column partially supports the current definition of the element, rendering a message for authorization to adapt the database table.

14. The computer implemented method of claim 8, wherein the data entity comprises a plurality of nodes and relationships between the plurality of nodes, and the plurality of nodes comprises one or more elements defined by data types.

15. A computing system comprising:
at least one processor; and
one or more memory devices communicative with the at least one processor, wherein the one or more memory devices store instructions to:
instruct a data repository to modify a database table based on a current definition of an element corresponding to a node of a data entity;
receive an error message when the current definition of the element is incompatible with a definition associated with a corresponding column of the database table;
determine whether an error is a data type change error by analyzing the error message;
compare the definition of the corresponding column of the database table and the current definition of the element when the error is the data type change error; and
based on the comparison, trigger the database table for database table adaption corresponding to the current definition of the element when the definition of the corresponding column supports the current definition of the element.

16. The computing system of claim 15, wherein the database table in the data repository comprises one or more columns mapped to one or more elements associated with the node of the data entity and one or more rows storing data.

17. The computing system of claim 15, wherein when the current definition of the element is compatible with the definition of the corresponding column of the database table, modify the definition of the corresponding column to the current definition of the element.

18. The computing system of claim 15, wherein when the error is not the data type change error, render a message to adapt the database table.

19. The computing system of claim 15, wherein based on the comparison, when the definition of the corresponding column does not support the current definition of the element, render a message for manual adaption of the database table indicating possible data loss due to adapting the database table.

20. The computing system of claim 15, wherein based on the comparison, when the definition of the corresponding column partially supports the current definition of the element, render a message for authorization to adapt the database table.
